(19) United States
(12) Patent Application Publication
(10) Pub. No.: US 2008/0142013 A1
(43) Pub. Date: Jun. 19, 2008

(54) Exhaust Apparatus For Use in Administering Positive Pressure Therapy Through the Nose or Mouth

(76) Inventors: Michael David Hallett, Sydney (AU); Michael Kassipillai Gunaratnam, Marsfield (AU)

Correspondence Address: Dr. Michael Hallett, Unit 803 / 8 Distillery Drive, Pyrmont, 2009, omitted

(21) Appl. No.: 11/852,303

(22) Filed: Sep. 9, 2007

(30) Foreign Application Priority Data
Sep. 11, 2006 (AU) 2006904948
Sep. 11, 2006 (AU) 2006904950

(51) Int. Cl. A62B 9/02

(52) U.S. Cl. 128/205.24

(57) ABSTRACT

We describe the use of a flow directing apparatus for incorporation into a patient mask or adjacent to it and for use with a source of pressurized breathable gas such as electronically or electronically controlled fan blower or positive displacement ventilator to provide nasal or oro-nasally administered continuous positive airway pressure or bi level therapies. Such therapies are commonly used to treat sleep disordered breathing including sleep apnea and other syndromes, as well as ventilatory insufficiency. The valve apparatus includes means to direct expired air to atmosphere and inspired air from a pressure source to a user's airway. In this way advantage is provided compared to alternative means as described in the prior art which vent a user's expired gas to atmosphere through a fixed open vent.

### CROSS REFERENCE TO RELATED APPLICATIONS

This patent is a full specification based on Australian provisional patent applications with numbers 2006904948, 2006904950

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND TO THE INVENTION

The prior art in relation to exhaust valves used with nasally administered continuous positive airway pressure (CPAP) or active ventilation techniques, where a range of pressures are often used, a lower pressure for a substantial period of exhalation compared to inspiration, are related commercially to a fixed leak to atmosphere; that is a vent of fixed cross sectional area and the flow varies in proportion to the applied pressure (square root of pressure) within the circuit comprising the flow and pressure source, a connecting tube, nasal mouth mask and the users airway and lung network. The users is able to exhale expired carbon dioxide, a by product of metabolism, through the vent, usually placed in the mask or adjacent to it and then to atmosphere. Such systems are typically used with single tube delivery systems, that is the flow and pressure sources is connected to the mask and vent by a single tube.

One of the significant issues with this arrangement is to ensure the adequate removal of carbon dioxide, a waste gas of metabolism, from the patient circuit. Because the flow is proportional to the administered pressure, a minimum pressure must be applied to avoid accumulation of waste gas in the circuit and rebreathing in inhalation by the patient. Typically administered pressures can range between 4 cm water (a lower pressure is possible but the designer must ensure adequate leak flow to wash out CO2—the figure is a typical minimum value and up to 40 cm H2O in some ventilation applications. It can be immediately appreciated that if the vent must be designed, in terms of its cross sectional area, to permit adequate outflow at 4 cm H2O, the outflow therefore at higher pressures, say 20 cm will constitute excess flow, which provide no useful medical or other benefit. For example, if the vent is designed to provide a vent flow of 20 l/min at 4 cmH20 then at 20 cmH20 it will provide a flow of 45 l/min. Furthermore, other factors such as increased air flow noise, air flow cooling and blowing and nasal drying are worsened as the pressure, and hence flow, is increased.

Despite this deficiency a fixed size vent remains the usual method of providing exhaust venting in commercially available mask system for nasal or oro-nasally administered CPAP, for example as used to treat sleep apnea (Sullivan C E, Berthon Jones M and Issa FG. “Treatment of obstructive apnea with continuous positive airway applied through the nose” Am Rev Respir Dis 1982 125. p 107 and bi-level ventilation such as described in U.S. Pat. No. 5,148,802.

The prior has attempted to improve the design of the vent in this application to provide a vent flow that is independent of flow i.e. either the flow remains constant with pressure or even reduces to some extent, albeit small extent during inhalation. These are disclosed in U.S. Pat. Nos. 5,685,296, 6,584,977, 6,889,692. These devices provide a means for flow regulation and differ to pressure regulators as described in U.S. Pat. No. 4,821,767, which provides a means for regulating a high pressure source to a low pressure constant source on a patient demand principle. However, this device is not applicable to low pressure sources such as fan driven/electrically controlled device

U.S. Pat. No. 7,066,175 B2 describes a mask apparatus for use with a pneumatically controlled CPAP device to deliver breathable gas such as 100% oxygen for acute care emergency care situations. This device uses a disc valve to direct flow to the atmosphere during expiration. This device represents a novel approach over the constant flow devices described above and is aimed at preserving oxygen use from a pressurized source such as an oxygen bottle.

### SUMMARY OF THE INVENTION

We describe the use of a flow directing apparatus for incorporation into the patient mask or adjacent to it and for use with electronically or electronically controlled fan blowers or positive displacement ventilators to provide nasal or oro-nasally administered CPAP or bi level therapies. These devices will provide a pressured source of breathable gas (usually room air or oxygen enriched room air) Typical source pressures are in the range 0 to 50 cm H20, the exact pressures or combinations being determined by individual patient requirements. Applicable conditions can include but not limited to treatment of sleep apnea, sleep hyperventilation syndromes, lung disease. The device is able to direct exhaust gases to atmosphere during expiration, while directing air to patients airway during inhalation. Hence the device is unique compared to the constant or variable flow exhaust area devices as described in the prior art and does not depend at all on a continuous bias flow. The operation of the device can be most easily described as an automatically adjusting PEEP (positive end expiratory pressure) valve, where the PEEP pressure is governed by the pressure delivered by an electrically operated and hence variable pressure source as opposed to a manually adjusted mechanical design. This device has important implications for use in positive pressure therapies particularly those that are administered via a face mask and hence includes the upper airway, as opposed users who are acutely intubated. Specifically, such as system may be used where the pressure is constant (CPAP) or varying i.e. pressures are varied during the respiratory cycle being higher to actively inflate long and reduced to deflate the lung to varying degrees and needs of the treatment. For example, during active assisted inhalation, pressurized air from the source is actively directed exclusively to the patients airway in the absence of unintended mask leaks. Conversely when the pressure source senses or preempts an expiratory emptying, the system is able to direct air exclusively to the atmosphere. In this context only tidal air is expired to atmosphere in the absence of a mask leak or perfectly sealed system. This is contrast to the prior art wherein bi level devices, such as described in U.S. Pat. No. 5,148,802 where the mask system described is of a fixed vent size type. This means that during exhalation expired air will be partially transmitted down the gas delivery tube from the pressure source and only partially out the exhalation vent. It will require fixed period of time to adequately wash out the CO2 from the tube prior to the next inhalation cycle. This is a significant disadvantage of the prior art and the need to optimize the vent size to ensure rapid CO2 washout prior to the next inspiration. Clinically, it has been observed in nasal ventilation bi-level systems at rapid respiratory rates, as much as 50% of the expired tidal volume is rebreathed. Clearly in acute situations where patients may be very hypercapnic and in respiratory distress, rebreathing such a high proportion of their tidal volume may lead to treatment failure and need for more complex intubation. Despite this shortcoming, in view of the added management issues with intubation nasal ventilation will be the preferred line of treatment. Furthermore the invention disclosed here will require an alternative arrangement for triggering specifically from expiration to inspiration. Hence the prior art does not anticipate the invention when used in a bi level mode and it provides the advantages which include superior CO2 removal and potential for less rebreathing, reduced source flow requirements, reduced need for humidification or when external humidification is required improved efficiency, improved noise characteristics, and absence of biased flow onto sleeping partners.

### BRIEF DESCRIPTION OF THE DRAWINGS

FIGS. 1A-C and 3A-B show an intermittent exhaust vent based on a pivoting valve, in accordance with a first embodiment of the invention.

FIGS. 2A-D show an intermittent exhaust vent based on a valve with linear motion which is an embodiment of the prior art . . . .

FIGS. 3C-D show a further embodiments as to sealing the pivoting valve element to the primary chamber.

FIGS. 4A-D show a pivoting valve intermittent exhaust vent in accordance with a further embodiment of the invention.

FIG. 5 shows an intermittent exhaust vent assembly installed into a mask system.

FIGS. 6A-C show embodiments as to sealing the valve sealing face to the exhaust passage.

FIGS. 7A-D show an intermittent exhaust vent assembly integrated into a nasal mask frame.

FIGS. 8A-D show an intermittent exhaust vent assembly integrated into a nose-mouth mask frame.

FIGS. 9A-B show a pivoting valve intermittent exhaust vent in accordance with a further embodiment of the invention wherein contact switches or sensors are provided to detect extreme positions of valve movement.

FIGS. 9C-D show a pivoting valve intermittent exhaust vent in accordance with a further embodiment of the invention wherein proximity sensors are provided to detect near extreme positions of valve movement.

FIGS. 10A-B show a pivoting valve intermittent exhaust vent in accordance with a further embodiment of the invention wherein a rotary sensor is provided to detect degrees of valve movement.

### DETAILED DESCRIPTION OF THE INVENTION

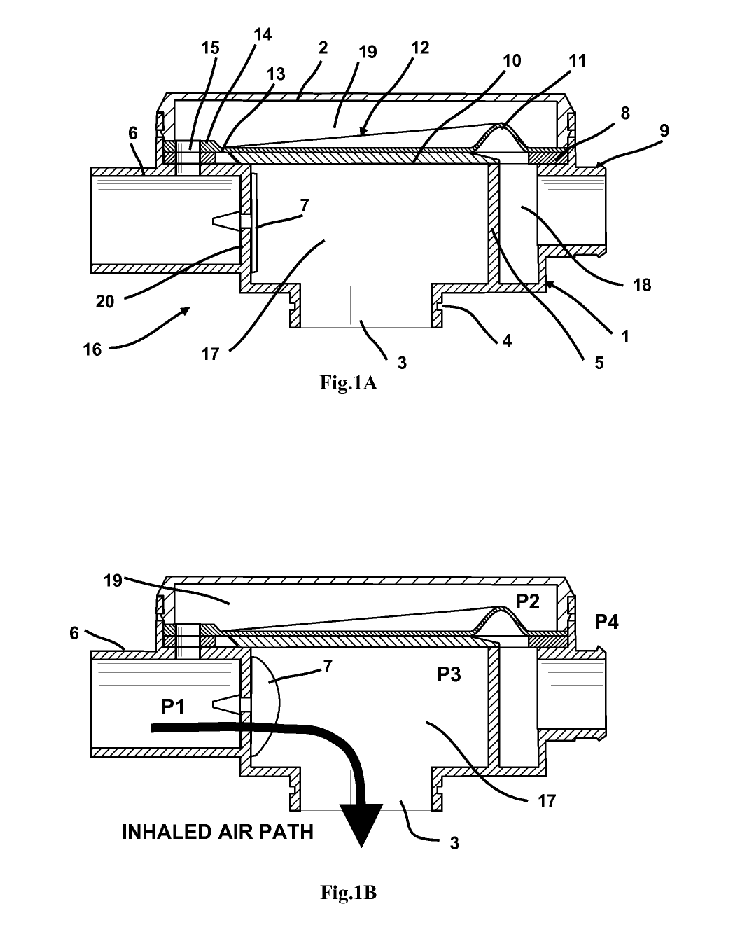

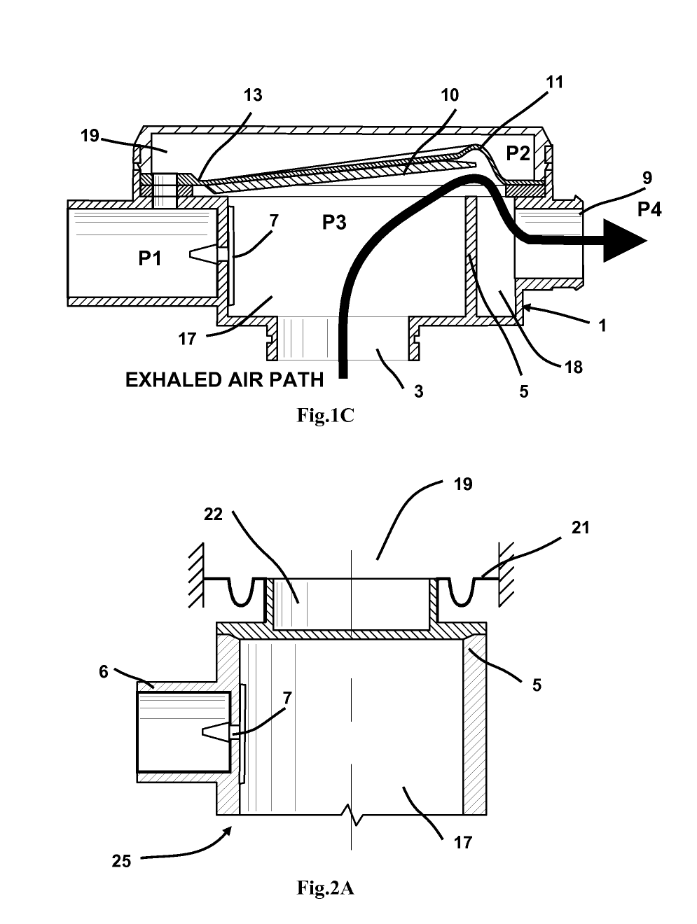

FIGS. 1A-1D illustrate a first embodiment of the invention. Referring to FIG. 1A, a valve assembly 16 comprises a rigid valve body 1 which includes an inlet passage 6 which is supplied with breathable gas under pressure. Inlet passage 6 terminates at an inner peripheral wall 5 where it intersects primary chamber 17. A non-return valve 7 is applied at the junction between the inlet passage 6 and the primary chamber 17. Non-return valve is attached to the rigid valve body 1. In the example shown, non-return valve 7 comprises a resilient flap weakly biased to the closed position and structured to deflect into two halves about a central line defined by mounting bar 20 which symmetrically bridges the junction between inlet passage 6 and primary chamber 17. Means of attachment comprising a barb-through-hole arrangement as widely used for this type of valve. It will be appreciated that the non-return valve 7 may take alternate forms such as a resilient flap weakly biased to the closed position and structured to pivot about a peripheral line tangent to the junction between inlet passage 6 and primary chamber 17. Non-return valve 7 prevents or minimizes backflow of patient exhalation from exiting via the inlet passage 6, thereby forcing a majority of exhaled air to work towards actuating the exhaust valve.

Also intersecting primary chamber 17 is patient connection passage 3 which provides a route for the transmission of breathable gas to and from the patient and primary chamber 17. Features, such as groove 4 provide a means whereby the entire valve assembly 16 may be retained to a mask frame (not shown), which is in turn, sealably attached to the patient's airway.

Atop inner peripheral wall 5 is valve pressure plate 10 which is attached to flexible elastic membrane 12 either by mechanical means, or alternatively by adhesive or magnetic bond, or alternatively being co-molded with flexible membrane. Alternatively, pressure plate may further be an extension of and integral with membrane 12, and having increased stiffness against bending by virtue of geometric section such as increased thickness or ribs.

When in contact with inner peripheral wall 5, valve pressure plate 10 seals and separates primary chamber 17 from communication with exhaust passage 9.

Membrane 12 is attached to a semi-rigid backing plate 8 by mechanical means, or alternatively by adhesive or magnetic bond, or alternatively being co-molded with flexible membrane. Alternatively, backing plate may further be an extension of and integral with membrane 12, and having increased stiffness against bending by virtue of geometric section such as increased thickness or ribs. The compression of the backing plate and membrane between the lid 2 and supporting surface of valve body 1 forms a gasket style seal against the escape of breathable gas.

For all embodiments discussed herein, the lid is retained to the valve body or mask frame either by integral mechanical means such as clips, or by external mechanical means such as a separate clip or by the headgear, which spans the top of the lid and applies force towards the patient's face.

For all embodiments discussed herein, membrane 12 features compliant geometry which permit it to deflect in a manner which offers minimal resistance to rotation of the valve pressure plate 10 and maximizes the work of exhalation in actuating the valve. Convoluted section(s) 11 is an example of said compliant geometry.

For all embodiments discussed herein; P1 denotes the inlet pressure supplied by the flow generator, P2 denotes the bias pressure applied on the upper side of the membrane 12, P3 denotes the primary chamber pressure and is in communication with the patient via patient connection passage 3. P4 denotes the ambient atmospheric pressure.

For all embodiments discussed herein, bias pressure passage(s) 15 connect inlet 6 to bias pressure chamber 19, which is defined between lid 2, and membrane 12. Bias pressure passage 15 is sized to have a cross-sectional area sufficiently large such that pressure drops between P1 and P2 are minimized. Hence, P2 is assumed to be equal at all times to P1.

Elastic membrane 12 may have a thicker and stiffer portion 14 which makes an abrupt transition 13 to the thin general membrane thickness. Transition 13 acts as an elastic hinge about which valve pressure plate 10 pivots. Alternatively pressure plate 10 may rotate about a classical pivot or hinge for example of a pin-in-hole type. Alternatively, membrane 12 may be of constant thickness and the pivot defined at the line 13 which would be located adjacent to the edge of the rigid backing plate 8.

Peripheral chamber 18 is external to inner peripheral wall 5, and connects primary chamber 17 to exhaust passage 9 when valve pressure plate 10 pivots open.

FIG. 1B shows the configuration of the valve of FIG. 1A under patient inhalation. During inhalation, the pressure P3 within the primary pressure chamber decreases to a level below inlet pressure P1 and forces open the non-return valve 7, thereby admitting a flow of breathable gas from the flow generator into the primary chamber 17. P2, which equals P1, exceeds P3. The resulting pressure difference presses valve pressure plate 10 closed against inner peripheral wall 5. Consequently, flow from the flow generator is directed from the primary chamber 17 via patient connection passage 3, to be inhaled by the patient.

FIG. 1C shows the configuration of the valve of FIG. 1A under patient exhalation. During exhalation, P3, the pressure within the primary pressure chamber increases above bias pressure P2 and inlet pressure P1. Non-return valve 7 is forced closed, and valve pressure plate 10 is forced open, permitting exhaled air to escape into peripheral chamber 18, then to be released via exhaust passage 9 out to atmosphere at lower ambient pressure P4.

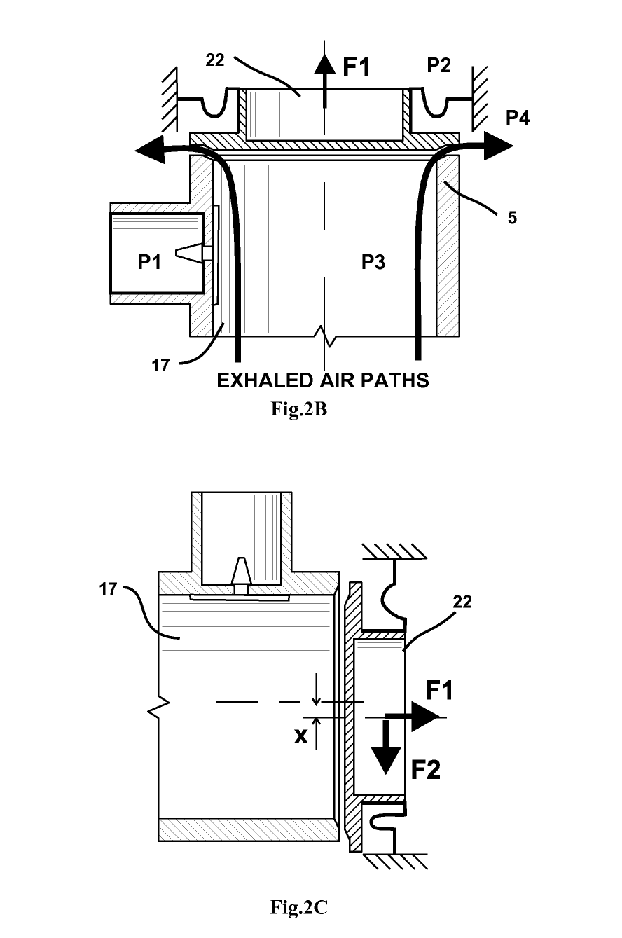

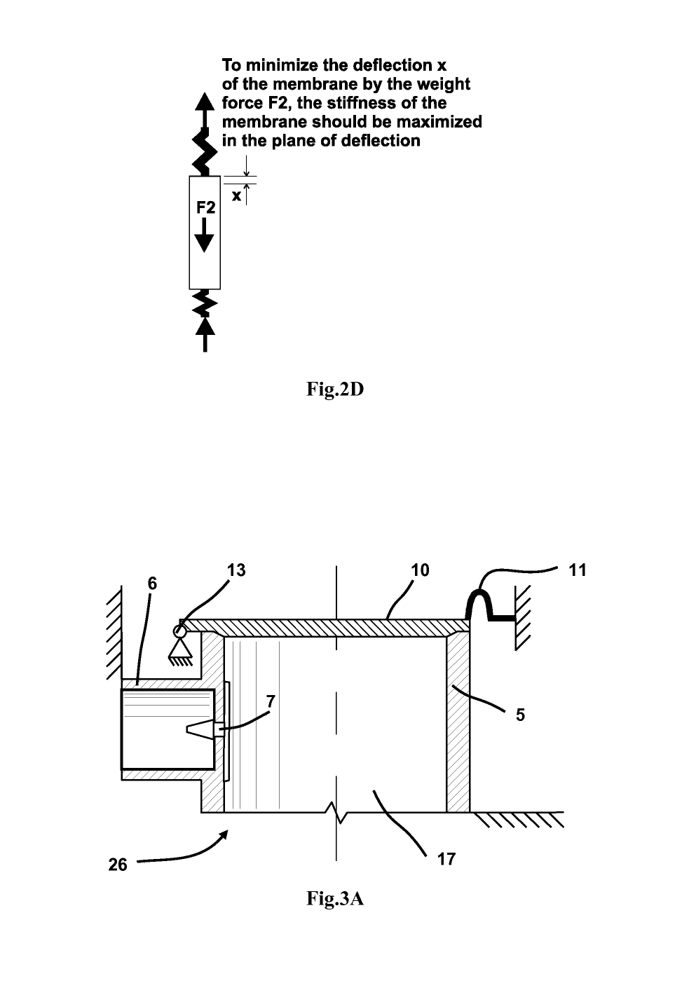

FIGS. 2A-2D reflect prior art embodiment of the valve described in U.S. Pat. No. 7,066,175 B2 and focus on details immediately surrounding the primary chamber with other features shown in minimal detail. The membrane 21 shown in FIGS. 2A-2C is analogous to the membrane 12 shown in FIGS. 1A-1C, and pressure plate 22 in FIGS. 2A-2C is analogous to the pressure plate 10 shown in FIGS. 1A-1C. It should be noted that in the embodiments shown in FIGS. 2A-2C, the membrane performs 2 functions; firstly that of a flexible barrier or seal between the bias chamber 19 at P2 and the primary chamber 17 at P3, and secondly that of aligning the sealing plate such that it minimizes misalignments denoted by x as shown in FIG. 2C. These misalignments may be due to the lateral forces incurred by the weight of the sealing plate, and would be intensified in the event that the valve is oriented as shown in FIG. 2C, which is possible if the patient is wearing the valve in a mask during sleep.

As shown schematically in FIG. 2D, the degree of misalignment is dependent on the stiffness of the membrane in the plane of misalignment.

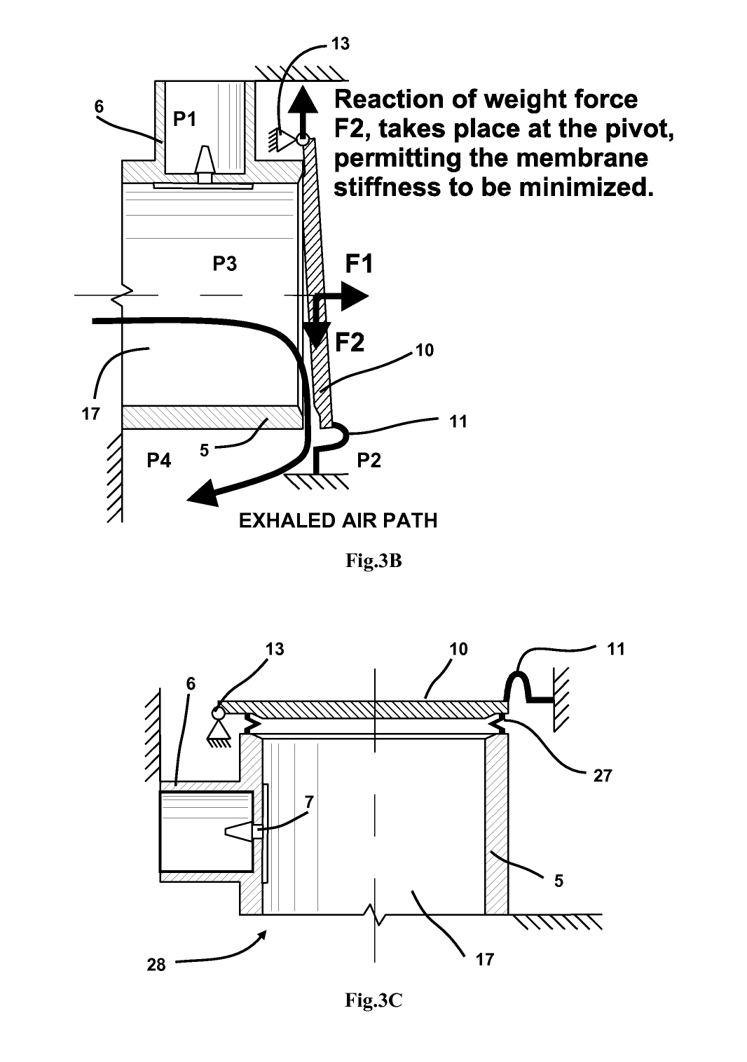

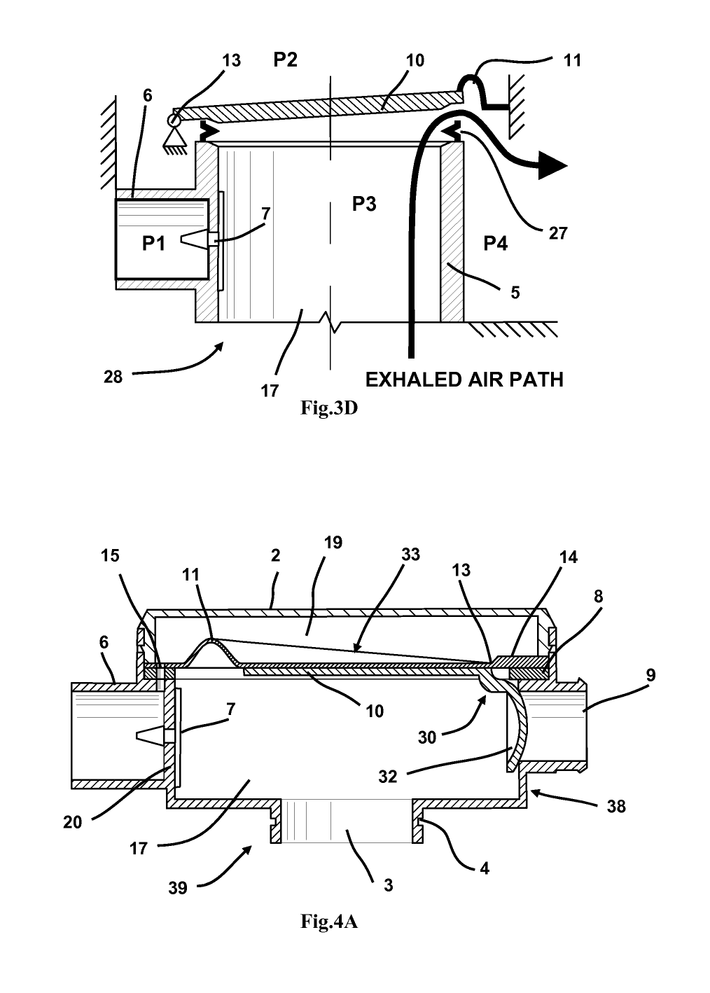

In contrast, FIGS. 3A-3B show that the addition of a pivot 13 takes up the reaction to lateral forces during sleep movement, thereby freeing the membrane of the requirement to react lateral forces. Consequently membrane thickness and corresponding stiffness may be minimized. Minimizing the membrane stiffness maximizes its sensitivity, and thereby decreases the amount of respiratory effort required by the patient in order to actuate the valve.

FIGS. 3C-3D show a further embodiment for sealing the pressure plate 10 to the primary chamber 17 by means of a flexible elastomeric seal 27 which is compressed between the sealing plate 10 and the inner peripheral wall 5. As shown the flexible seal 27 is attached atop the inner peripheral wall 5. Alternatively flexible seal 27 may be attached to the pressure plate 10. The means of attachment may be mechanical, adhesive, by co-molding, or alternatively if the sealing plate is a molded integral extension of the membrane 12, the flexible seal 27 may be a molded extension of sealing plate 10.

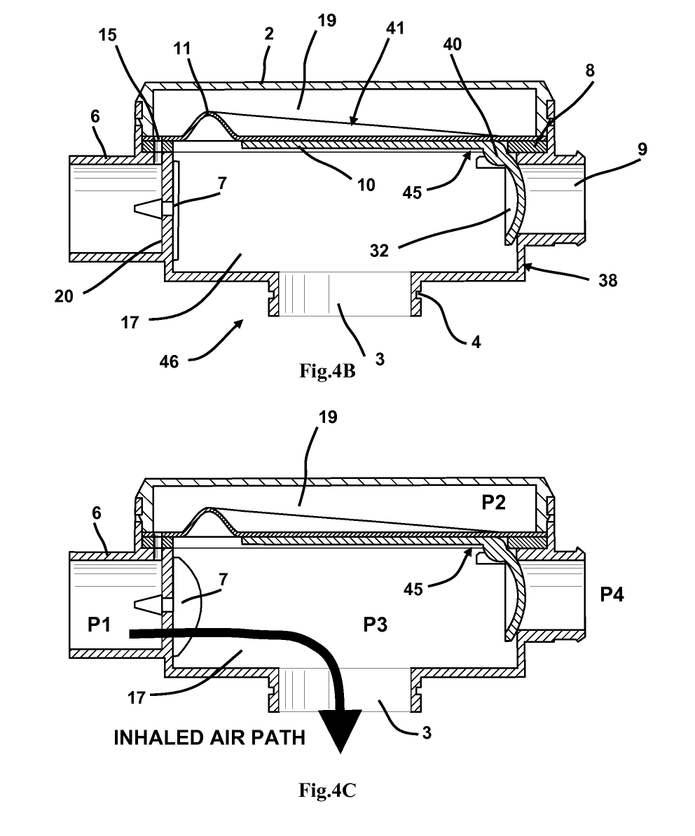

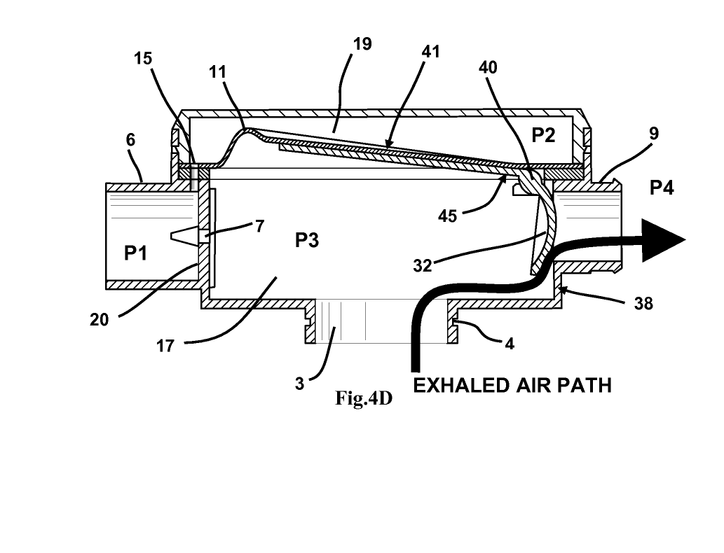

FIG. 4A shows a further embodiment of the valve; valve assembly 39, wherein the primary chamber 17 features no inner peripheral wall 5. Instead, the valve pressure plate 10 forms a ‘rocker’ 30 arrangement about pivot 13, and a sealing face 32 lies on the other side of the pivot and acts to block or open the exhaust outlet 9.

FIG. 4B shows a further embodiment of the valve shown in 4A; valve assembly 46, wherein the rocker 45 rotates about a classical (pin-in-hole style) pivot 40 as opposed to the elastic pivot 13 shown in 4A.

FIG. 4C shows the valve of 4B under patient inhalation. During inhalation, P3 within the primary pressure chamber decreases to a level below inlet pressure P1 and forces open the non-return valve 7, thereby admitting airflow from the flow generator into the primary chamber 17. P2 which equals P1, exceeds P3.

For all embodiments herein, the projected area of pressure plate 10 greatly exceeds that of sealing face 32. Therefore, the positive pressure difference of P2 relative to P3 creates a net moment that tends to rotate rocker 45 anti-clockwise as shown in FIG. 4C, forcing sealing face 32 to block exhaust outlet 9. Consequently, flow from the flow generator is directed from the primary chamber 17 via patient connection passage 3, to be inhaled by the patient.

FIG. 4D shows the valve of 4B under patient exhalation. During exhalation, P3 within the primary pressure chamber increases above bias pressure P2 and inlet pressure P1. Non-return valve 7 is forced closed, and the pressure difference of P3 relative to P2, creates a net moment that tends to rotate rocker 45 clockwise as shown in the FIG. 4D, forcing sealing face 32 away from, and thereby opening exhaust outlet 9 permitting exhaled air to be released via exhaust passage 9 out to atmosphere at lower ambient pressure P4.

FIG. 5 illustrates a valve assembly 46 installed in a mask system 53 comprising a mask frame 50, retaining means such as a collar 49 which engages grooves 4 in valve assembly. Collar 49 and connection passage 3 may be generally circular in cross-section, thereby permitting the valve assembly 46 to rotate relative to the mask system 53. FIG. 5 also illustrates a silencer 48 attached to the exhaust passage 9 and including a converging exit nozzle(s) 47 shaped to further reduce exhaust vent noise. Silencer 49 may be elastomeric in construction, or feature an elastomeric interface, to reduce noise transmitted by the semi-rigid structures of the mask frame 50 and valve assembly 46 to the exit nozzle(s) 47. Silencer 49 and exhaust passage 9 may be of generally circular cross-section, permitting the direction of venting via exit nozzle(s) to be selected by the patient.

Mask system 53 includes a cushion 51 for sealing against the patient's face and also includes headgear 52 for retaining the mask system 53 to the patient's face. It should be noted that many alternative patient interfaces may be applied to mask system 53 including nasal, individual nares seals, full-face or nose-and-mouth.

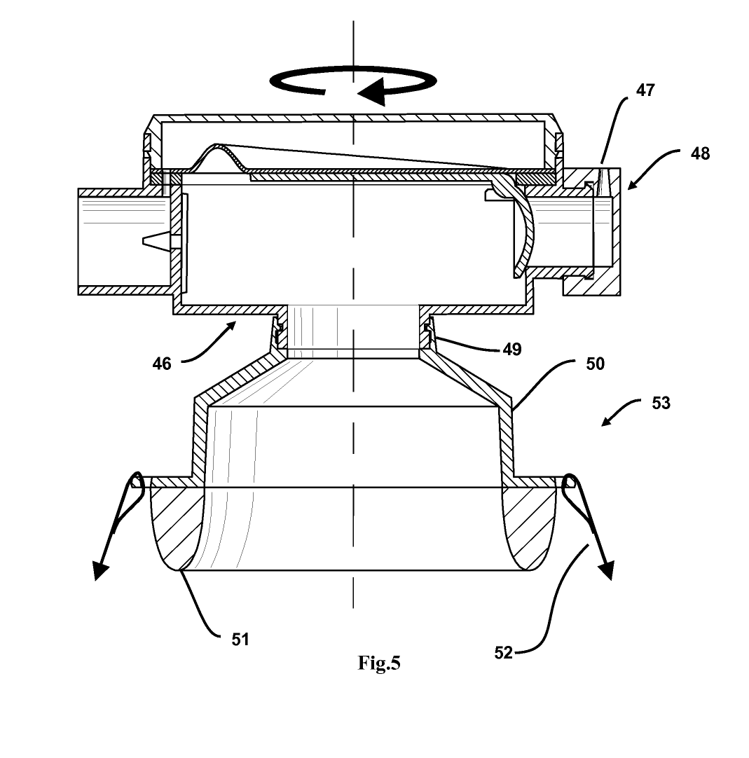

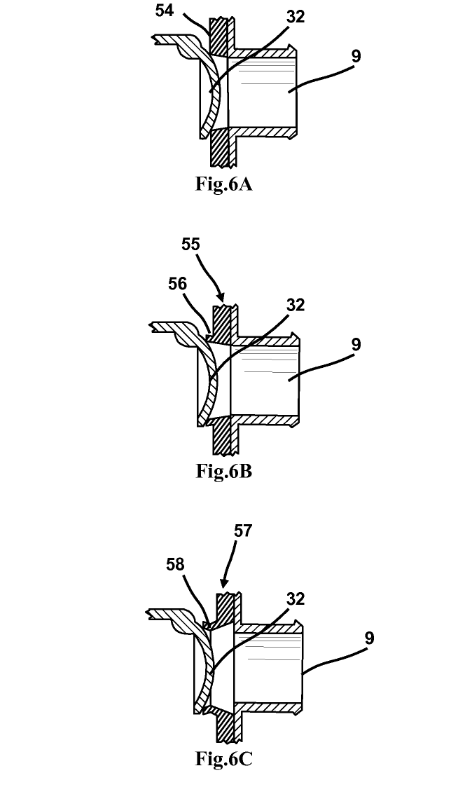

FIGS. 6A-6C illustrate an alternative sealing arrangements between valve sealing face 32 and exhaust outlet 9. FIG. 6A shows a plain elastomeric gasket 54. FIG. 6B shows an elastomeric gasket 55 including a projecting lip 56. FIG. 6C shown an elastomeric gasket 57 including a lip 58.

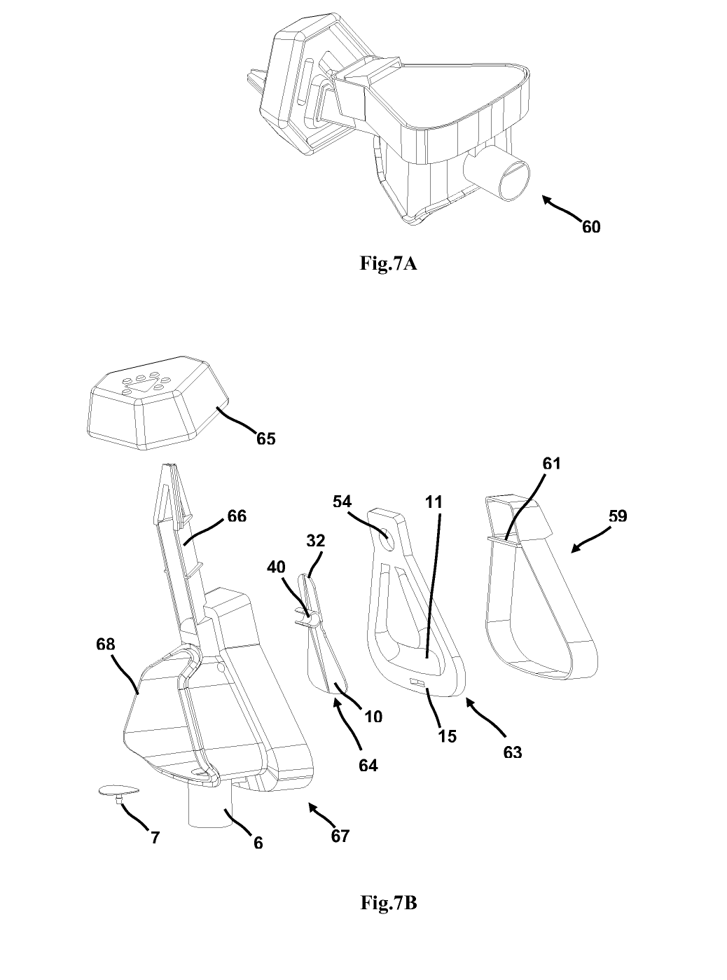

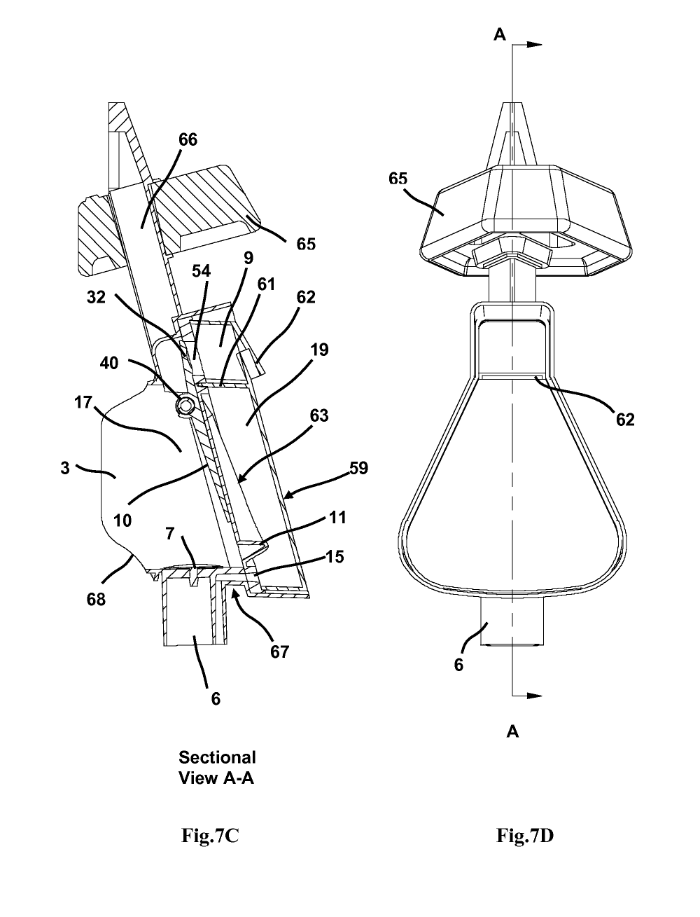

FIGS. 7A-7D illustrate an embodiment of a valve assembly integrated into a mask system including a nasal patient interface ie. enclosing the patient's nose within a sealed pressurized area.

FIG. 7A shows a perspective view of the mask system 60.

FIG. 7B shows an exploded view of the mask system of FIG. 7A. comprising a mask frame 67, soft, elastomeric forehead support 65 which is rotatable and installed onto forehead support post 66, and cushion mounting rim 68 (cushion and headgear are not shown). Mask system 60 also includes components required to effect the functions of an intermittent exhaust valve, including, non-return valve 7, valve rocker 64 which includes pivot 40, pressure plate 10 and sealing face 32.

Mask system 60 also includes a membrane 63 which includes a convolution 11, bias pressure passage 15 and gasket seal 54. Mask system 60 also includes a lid 59 which includes an exhaust passage 9 separated from bias chamber 19 by a dividing wall 61, and includes an exhaust vent nozzle 62.

FIG. 7D shows a front view of the integrated mask valve system, and FIG. 7C shows a sectional view derived from FIG. 7D.

Inhalation and exhalation functions of the valve follow that described for the valve illustrated in FIGS. 4B-4D. It should be noted that although a nasal mask embodiment is illustrated, the general configuration shown in FIGS. 7A-7D may be adapted to nasal or full-face mask configurations.

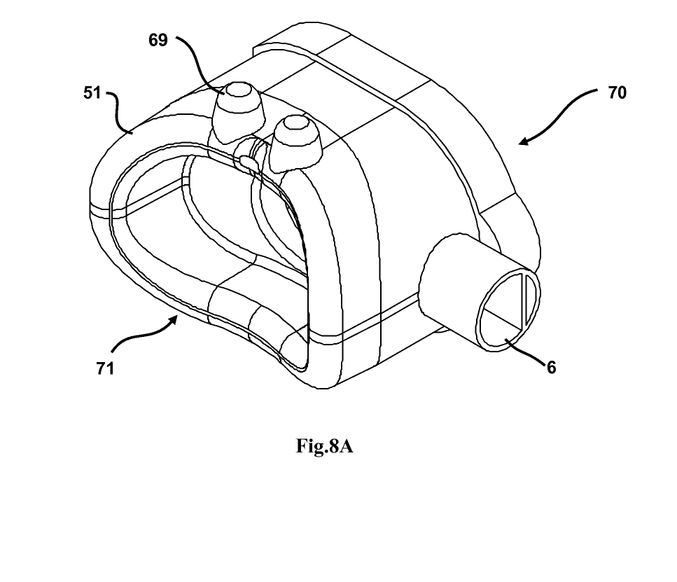

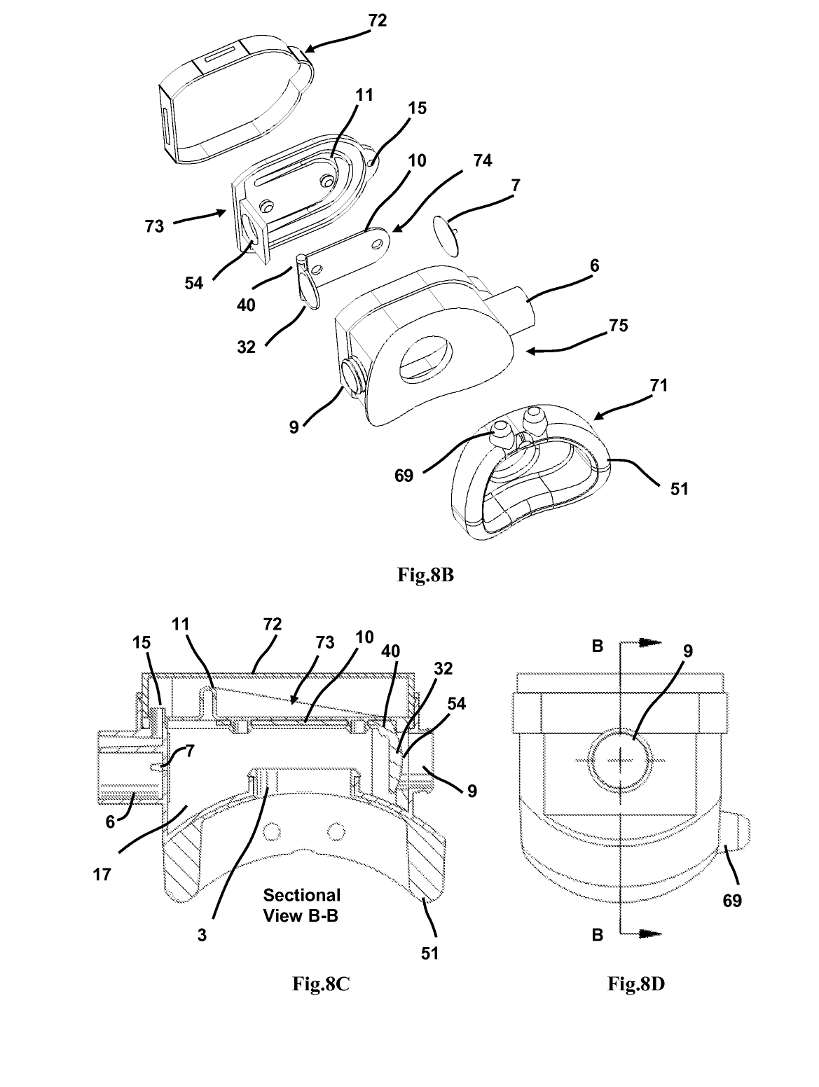

FIGS. 8A-8D illustrate an embodiment of a valve assembly integrated into a mask system including a nose and mouth patient interface ie. enclosing the patient's mouth within a sealed pressurized area and also including projections for sealing in and/or around the nares.

FIG. 8A shows a perspective view of the mask system 70.

FIG. 8B shows an exploded view of the mask system of FIG. 8A. comprising a mask frame 75 (headgear is not shown).

Mask system 70 also includes componentry required to effect the functions of an intermittent exhaust valve, including, non-return valve 7, valve rocker 74 which includes pivot 40 and pressure plate 10 and sealing face 32.

Mask system 60 also includes membrane 73 which includes a convolution 11, bias pressure passage 15 and gasket seal 54. Mask system 70 also includes a lid 72.

Mask system 70 also includes a cushion 71 including portion to seal around the mouth 51 and projections to seal in or around the nares 69.

FIG. 8D shows a side view of the integrated mask valve system, and FIG. 8C shows a sectional view derived from FIG. 8D.

Inhalation and exhalation functions of the valve follow that described for the valve illustrated in FIGS. 4B-4D.

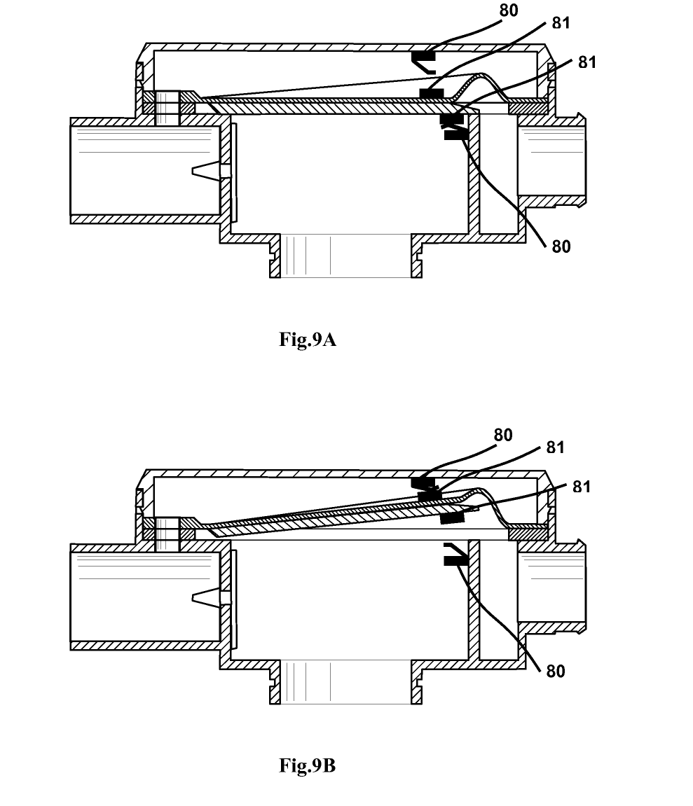

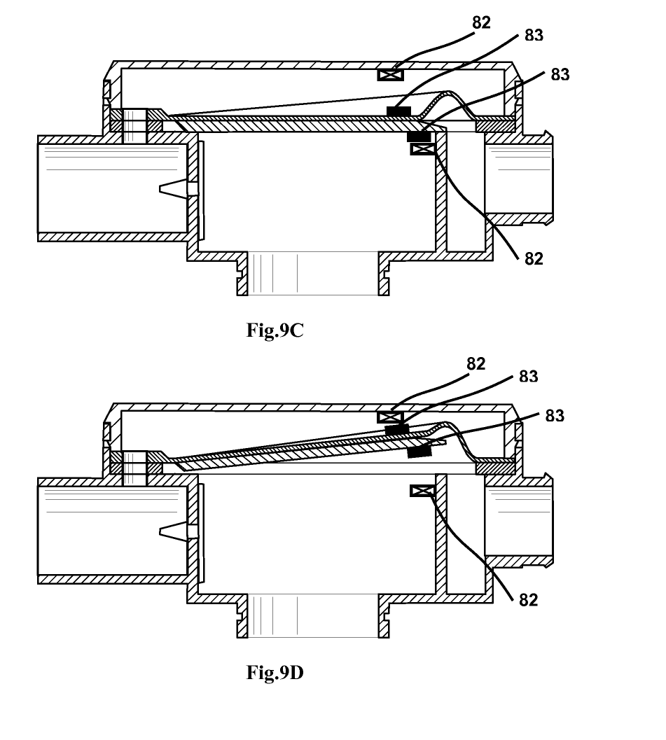

FIG. 9A-B show further embodiments of the valve assembly shown in FIG. 1A; wherein contact switches 80 are provided to be activated upon contact with pads 81. It may be appreciated that the positional arrangements of 80 and 81 shown may be reversed, that pads 81 may be integral features of valve components and that a similar sensor configuration may be applied to a valve assembly of the style shown in FIG. 4A. Contact switches 80 detect actuation of the valve mechanism to extreme positions of either fully open or fully closed.

FIG. 9C-D show further embodiments of the valve assembly shown in 1A; wherein proximity sensor 82 are provided to be activated upon contact with targets 83. It may be appreciated that the positional arrangements of 82 and 83 shown may be reversed, that a range of sensor types may be used including magnetic, optical or acoustic and that a similar sensor configuration may be applied to a valve assembly of the style shown in FIG. 4A. Proximity sensors 82 detect actuation of the valve mechanism to near extreme positions of either fully open or fully closed.

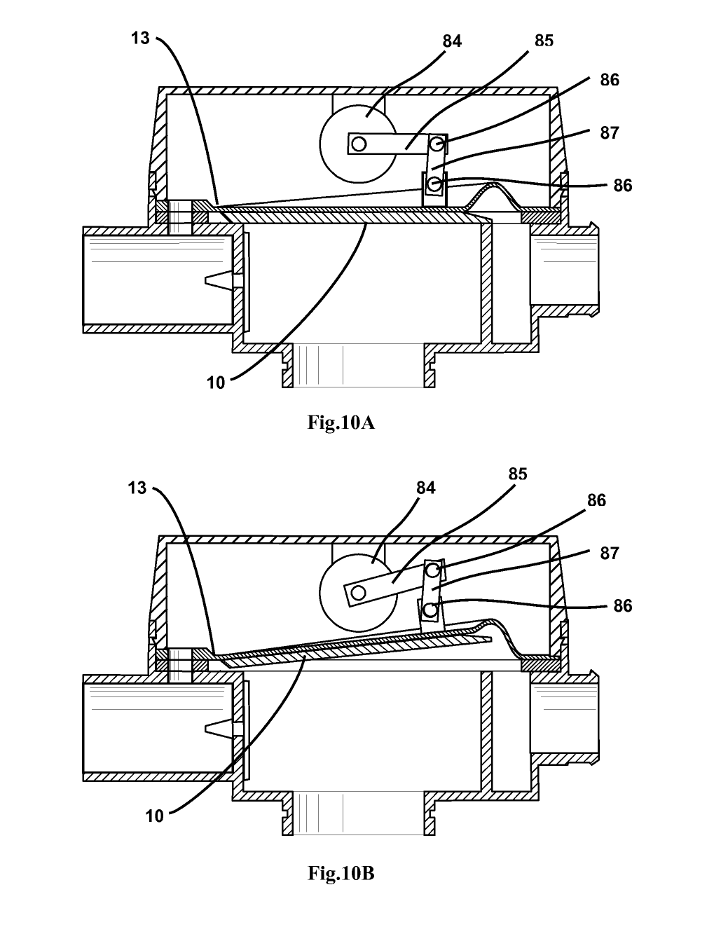

FIG. 10A-B show further embodiments of the valve assembly shown in 1A; wherein a rotational position sensor 84, capable of detecting changes in angular displacement is provided for detecting angular displacement of the valve rocker or pressure plate 10. The rotational position sensor 84 may be connected to the pressure plate 10 by links 85, 87 which rotate about pivots 86. Alternatively a link pivoting at the sensor 84 and running in a slot provided in pressure plate 10 may be used. Rotational position sensor 84 may be either, but not limited to, a rotary potentiometer, a binary encoder or grayscale encoder. It may be appreciated that a similar sensor configuration may be applied to a valve assembly of the style shown in FIG. 4A. It may also be appreciated that if the rotational position sensor 84 acts as the pivot 13 for the valve rocker or pressure plate 10, then further links 85, 87 and pivots 86 are unnecessary. It may further be appreciated by those skilled in the art that the rotational sensor arrangement described may be substituted, for example by sensors based on relative linear motion or bending.

It is will be clear to those skilled in the art that the apparatus and embodiments described above provides means to direct flow from a user to atmosphere during exhalation and from the source of pressurized breathable gas to a user's respiratory system during inhalation. It will be further evident that during unintentional leaks, such as may be attributable to mask leaks or other mating surfaces, such as movable fittings and valves, air will flow from the pressure source to atmosphere independently of gas flow initiated by the user into or out of their respiratory system. Naturally it will be the aim of the mask system including the apparatus described to minimize these leaks by optimizing for example engineered mating surfaces as well optimizing the seal between the mask and user's facial tissues. Notwithstanding issues associated with unintentional leaks, it may be further appreciated that small intentional may be introduced into the apparatus if required. This may, for example, be advantageous to remove small amounts of retained carbon dioxide from within the mask frame if desired. The amount or intended leak would be set at a designer's discretion.

While the invention has been described with reference to a range of embodiments as described above, it will occur to those skilled in the art that various modifications and additions further to the disclosed methods discussed herein may be made without departing from the spirit and scope of the invention.

### MPEP 706/707 STATEMENT

If for any reason this application is not believed by the Examiner to be in full condition for allowance, applicants respectfully requests constructive assistance and suggestions of the Examiner, pursuant to M.P.E.P. 706.03 (d) and 707.070) in order that the applicants can place this application in allowable condition as soon as possible.

We claim:

1. A system where a source of pressurized breathable gas is administered through a user's nose or mouth or combination thereof wherein;
a source of breathable pressurized gas comprises an electrically operated fan or blower designed to provide a single or range of pressures during a respiratory cycle or a treatment session;
pressurized gas delivery means to a user includes a length of gas delivery tubing and a nasal or nose and mouth mask or similar sealing apparatus;
pressurized gas delivery means further includes an exhaust valve apparatus comprising mechanism whose action directs flow during lung filling and lung emptying where such means further provides;
during lung emptying, a volume of gas equal in value to a user's expired gas volume and additional volume attributable to any leaks, to be vented to atmosphere and;
during lung filling, a volume of gas equal in value to a user's inspired gas volume and additional volume attributable to any leaks, to be exclusively directed from a source of breathable pressurized gas to the mask apparatus and a volume of gas equal in value to a user's inspired gas volume into a user's respiratory system and;
in absence of gas flow into or out of a user's respiratory system, flow of gas from a source of breathable pressurized gas being equal to flow attributable to any leaks;
where leaks are attributable to unintentional leaks at appositional surfaces and small intentional leaks, where said small intentional leaks may be optionally introduced into the apparatus at a designer's discretion

2. An exhaust valve arrangement according to claim 1 for use between a patient and a source of a pressurized breathable gas, the exhaust valve arrangement comprising;
a housing (1,38,67,75) including
a primary chamber (17),
an inlet passage (6) structured to deliver breathable gas into the primary chamber,
an exhaust passage (9) structured to release exhaled air from the breathing circuit,
a patient connection passage (3) structured to connect the primary chamber (17) to the patient's air path either directly if the housing is an integral part of a mask, or indirectly if the housing interfaces with a mask,
an inner peripheral wall (5) surrounding the primary chamber (17),
a peripheral chamber (18) outside the inner peripheral wall (5) and in fluid connection with the exhaust passage (9),
a surface(s) structured to receive a membrane or membrane carrier (12,33, 41,63,73),
a surface(s) structured to receive and seal and retain a lid (2),
a structure (20) to receive a non-return valve (7).
a pressure plate (10) structured to seal the inner peripheral wall (5) against fluid connection between the primary chamber (17) and the peripheral chamber (18) and structured to connect to membrane (12).
a pivot (13,40) structured to permit pivoting pressure plate (10) to rotate about one axis of rotation.
a lid (2) structured to seal and define a bias chamber (19) above the membrane (12,41,63,73).
a bias pressure passage or passages (15) structured to effect fluid connection between the inlet passage (6) and the bias chamber (19).
a membrane (12,33, 41,63,73) structured to permit rotary deflection of the pressure plate (10) about the axis of rotation of the pivot (13,40) with minimal force and to the maximum angle of deflection and to seal bias chamber (19) from primary chamber (17), and which also effects fluid separation of bias chamber (19) from primary chamber (17).
a non-return valve (7) which closes connection of the inlet passage (6) to the primary chamber (17) when pressure in the primary chamber (17) exceeds pressure in the inlet passage (6).

3. An exhaust valve arrangement according to claim 1 for use between a patient and a structure to deliver a breathable gas to the patient, the exhaust valve arrangement comprising;
a housing (1,38,67,75) including
a primary chamber (17),
an inlet passage (6) structured to deliver breathable gas into the primary chamber,
an exhaust passage (9) structured to release exhaled air from the breathing circuit,
a patient connection passage (3) structured to connect the primary chamber (17) to the patient's airpath either directly if the housing is an integral part of a mask, or indirectly if the housing interfaces with a mask,
a surface(s) structured to receive a membrane or membrane carrier (12, 33,41,63,73),
a surface(s) structured to receive and seal and retain a lid (2),
a structure (20) to receive a non-return valve (7).
a pivot (13,40) structured to permit rocker (30,45) to rotate about one axis of rotation.
a rocker (30,45,64,74) including
a pressure plate (10) structured to attach to membrane (12, 33,41,63,73), a sealing face (32) in an orientation by a fixed angle relative to pressure plate (10) about pivot (13,40) and sized such that its projected area is smaller than that of pressure plate (10) by a factor permitting actuation of the rocker by patient breathing.
a sealing surface structured to receive and seal the sealing face (32).
a lid (2) structured to seal and define a bias chamber (19) above the membrane (12, 33,41,63,73).
a bias pressure passage or passages (15) structured to effect fluid connection between the inlet passage (6) and the bias chamber (19).
a membrane (12, 33,41,63,73) structured to permit rotary deflection of the rocker (30,45,64,74) about the axis of rotation of the pivot (13,40) with minimal force and to the maximum angle of deflection and to seal bias chamber (19) from primary chamber (17), and which also effects fluid separation of bias chamber (19) from primary chamber (17).
a non-return valve (7) which closes connection of the inlet passage (6) to the primary chamber (17) when pressure in the primary chamber (17) exceeds pressure in the inlet passage (6).

4. An exhaust valve arrangement according to claims 2 or 3 wherein the patient connection passage (3) features surfaces (4) slots or undercuts are provided to permit retention into a mask system.

5. An exhaust valve arrangement according to claims 2 or 3 wherein the housing is an integral part of a mask frame (75,67).

6. An exhaust valve arrangement according to claims 2 or 3 wherein the exhaust passage (9) releases dispelled air into a silencer (48) arrangement before releasing the exhaust to atmosphere.

7. A silencer arrangement according to claim 6 wherein the exhaust is subject to sound energy dissipating structures such as reduced exit area or tapering passages (47).

8. A silencer arrangement according to claim 6 wherein the silencer (48) is attached to make fluid connection with exhaust passage (9) by, or constructed from a flexible, resilient material whereby sound vibrations transmitted by the rigid valve housing structure (1,38,67,75) are dampened prior to release of the exhaust to atmosphere.

9. An exhaust valve arrangement according to claims 2 or 3 wherein the rigid portions of the valve (5,10,32) compress resilient, compliant seals (27,54,55,57) in the closed position

10. An exhaust valve arrangement according to claims 2 or 3 wherein the valve is fitted with sensors (80,82), which transmit opened and closed states to the controller of a source of pressurized breathable gas.

11. An exhaust valve arrangement according to claims 2 or 3 wherein the valve is fitted with sensor or sensors 84, which transmit the degree of valve opening to the controller of a source of pressurized breathable gas.
